(19) United States
(12) Patent Application Publication
(10) Pub. No.: US 2012/0286486 A1
(43) Pub. Date: Nov. 15, 2012

(54) Container With Retractable Wheels

(75) Inventors: James R. Varney, Maynard, MA (US); Bryan R. Hotaling, Harvard, MA (US); Rodney Garland Sparrow, Bolton, MA (US); John Wood Brooks, III, Maynard, MA (US)

(73) Assignee: Leaktite Corporation, Leominster, MA (US)

(21) Appl. No.: 13/106,331

(22) Filed: May 12, 2011

(51) Int. Cl. B62B 7/04; B65D 90/00

(52) U.S. Cl. 280/47.11; 220/694

(57) ABSTRACT

A container with retractable wheels. There is a base member having a perimeter shape, and a plurality of retractable wheel assemblies coupled to the base member. The wheel assemblies each have a leg that carries a wheel. The base member defines a cavity for each wheel assembly such that in a stowed position the wheel assemblies fully fit within the cavities and the legs define a portion of the perimeter shape of the base member.

### FIELD

This disclosure relates to a container with retractable wheels.

### BACKGROUND

Containers such as buckets, trash barrels, planters and the like can be heavy and thus difficult to transport when filled. Container dollies exist that are designed to carry a container to allow it to be wheeled. However, these dollies are separate assemblies that need to be stored and maintained when not in use. With many such dolly designs, the container simply sits on top of the dolly, perhaps in a small recess, which makes the dolly and container combination difficult to tilt or lift over obstacles, stairs or the like. In some cases the dollies are designed to be temporarily coupled to the container to allow for such lifting or tilting. However, the coupling can be tenuous. Also, this arrangement adds to the complexity of the construction of the dolly.

Some containers are made with wheels. Typically the wheels are fixed relative to the container, and project outwardly from the perimeter of the container. A problem is that such fixed-wheel containers consume additional floor or shelf space and often cannot be nested for storage.

### SUMMARY

Featured in this disclosure is a wheeled dolly comprising a base member having a perimeter shape, and a plurality of retractable wheel assemblies coupled to the base member, wherein the wheel assemblies each comprise a leg that carries a wheel. The base member defines a cavity for each wheel assembly such that in a stowed position the wheel assemblies fully fit within the cavities and the legs define a portion of the perimeter shape of the base member. The cavities may be defined by cavity walls in the base member. The legs may be coupled to and rotate relative to the cavity walls. The walls of each cavity may define one or more first features that are complementary to one or more second features on the leg, to allow the leg to be coupled to the cavity walls. Two stop positions may be defined between the walls of each cavity and the leg that is coupled to such walls. The stop positions may be defined by projecting features on either both of the walls or the leg, and receiving features on the other of either both of the walls or the leg.

Featured in another embodiment is an assembly comprising a container having a perimeter shape, and a plurality of retractable wheel assemblies coupled to the container, wherein the wheel assemblies each comprise a leg that carries a caster, and wherein the container defines a cavity for each wheel assembly. In a stowed position the wheel assemblies fully fit within the cavities and the legs define a portion of the perimeter shape of the container. The container may define a base portion, and the base portion may define the cavities. The assembly may comprise a container portion and a separate base portion that is mechanically coupled to the container portion. The container perimeter shape may be tapered at least toward the lower end of the container.

Featured in yet another embodiment is a wheeled dolly that is adapted to be coupled to an apparatus that is supported by the dolly. The apparatus has a number of first mechanical features. The dolly has a base comprising a base member and a number of second mechanical features. There are a plurality of wheel assemblies coupled to the base member and adapted to rest on a surface to support the base member above the surface. The apparatus has a bottom, and the first mechanical features are integral with the bottom. The dolly has a top, and the second mechanical features are integral with the top.

The first and second mechanical features may be matching features that fit together in an interference fit when the apparatus is coupled to the dolly. The apparatus may comprise a container. The container may have a round perimeter shape. The wheeled dolly may define a continuous external taper along at least the lower part of the container and all of the base. The first mechanical features may comprise raised annular bosses, and the second mechanical features may comprise posts. The posts may be at least in part located within the bosses. The posts and bosses may each define one or more projecting features such as rings, and the interference fits may be accomplished at least in part by a ring on a post moving past a ring on a boss. Each post may define a shoulder and a projection above the shoulder. The projections may be located in the bosses, and the bosses may sit on the shoulders.

The wheel assemblies may be retractable. The wheel assemblies may each comprise a leg that carries a caster. The base member may define a cavity for each wheel assembly, and in a stowed position the wheel assemblies may fully fit within the cavities and the legs may define a portion of the perimeter shape of the base. The cavities may be defined by cavity walls in the base member. The legs may be coupled to and rotate relative to the cavity walls. The walls of each cavity may define first features that are complementary to second features on the leg, to allow the leg to be coupled to the cavity walls. Two stop positions may be defined between the walls of each cavity and the leg that is coupled to such walls. The stop positions may be defined by projecting features on either both of the walls or the leg, and receiving features on the other of either both of the walls or the leg.

The container may be a bucket, and the bucket and the base may each be made of molded plastic. The base may further comprise an extension cord and one or more electrical receptacles powered by electrical power carried by the cord. The base may define a circumferential groove into which the extension cord fits so as to be fully within the perimeter shape of the base. The base may further comprise a light, a battery power source for the light, and a switch that controls power flow from the power source to the light.

Featured in another embodiment is an assembly comprising a molded plastic bucket having a round perimeter shape and a bottom, and defining a plurality of raised annular bosses projecting outwardly from the bottom. A molded plastic base member has a round perimeter shape and a top, and defines a plurality of posts projecting upwardly and located proximate the top. The posts each define a shoulder and a projection above the shoulder. There are a plurality of wheel assemblies, the wheel assemblies each comprising a leg that carries a caster. The base member may define a cavity for each wheel assembly. In a stowed position the wheel assemblies may fully fit within the cavities, with the legs defining a portion of the perimeter shape of the base member. The cavities may be defined by cavity walls in the base member and the legs may be coupled to and rotate relative to the cavity walls. The walls of each cavity may define features that interfit with the leg that is coupled to such walls, wherein two stop positions are defined between the walls of each cavity and the leg that is coupled to such walls. The bucket and the base may be fixedly coupled together via interference fits between the bosses and the posts, wherein each post fits within one of the bosses with the boss sitting on a shoulder, and wherein the posts and bosses each define projecting external rings and the interference fits are accomplished at least in part by the rings on the posts moving past the rings on the bosses. The assembly may define a continuous external taper along at least the lower part of the bucket and essentially all of the base when the wheel assemblies are in the stowed position.

Further featured is an assembly comprising a molded plastic bucket having a round perimeter shape and a bottom rim, with a groove defined in the bottom rim. There is a molded plastic base member having a round perimeter shape and a top rim, with a plurality of tabs projecting inwardly from the top rim. There are a plurality of wheel assemblies, the wheel assemblies each comprising a leg that carries a caster. The base member defines a cavity for each wheel assembly. In a stowed position the wheel assemblies fully fit within the cavities and the legs define a portion of the perimeter shape of the base member. The cavities are defined by cavity walls in the base member and the legs are coupled to and rotate relative to the cavity walls. The walls of each cavity define features that interfit with the leg that is coupled to such walls. Two stop positions are defined between the walls of each cavity and the leg that is coupled to such walls. The bucket and the base may be coupled together by the base member tabs fitting into the groove in the bottom rim of the bucket. The assembly may define a continuous external taper along at least the lower part of the bucket and essentially all of the base when the wheel assemblies are in the stowed position.

### BRIEF DESCRIPTION OF THE DRAWINGS

FIG. 1 is a perspective view of a container with retractable wheels.

FIG. 2 is a view of the container with retractable wheels of FIG. 1 before the container is coupled to the base.

FIG. 3 is a bottom perspective view of the container with retractable wheels of FIG. 1.

FIG. 4 is a disassembled bottom perspective view of the container with retractable wheels of FIG. 1.

FIG. 5 is a greatly enlarged partial cross-sectional view showing the manner in which the base is coupled to the container for the container with retractable wheels of FIG. 1.

FIG. 6 is a perspective view of the container with retractable wheels of FIG. 1, with the wheels retracted.

FIG. 7 is a bottom perspective view of the container with retractable wheels of FIG. 1, with three of the wheels retracted, one wheel deployed and one removed from the base.

FIG. 8 is a greatly enlarged bottom cross-sectional perspective view detailing aspects of the manner in which a wheel assembly is coupled to the base.

FIG. 9 is a similar view, but with the wheel assembly coupled to the base and in the stowed position.

FIG. 10 is a bottom plan view detailing a wheel assembly (with the caster removed for clarity purposes only) about to be coupled to the base.

FIG. 11 is a similar view but with the wheel assembly coupled to the base.

FIG. 12 is a view similar to that of FIG. 9, but with the wheel assembly deployed.

FIG. 13 is a view similar to that of FIG. 11 but with the wheel assembly deployed.

FIG. 14A shows a wheel assembly removed from its receiving cavity, which is shown in FIG. 14B.

FIG. 15 is a partial, disassembled view of a second embodiment of a container with retractable wheels.

FIG. 16 is a cross-sectional view similar to that of FIG. 15.

FIG. 17 is similar, but showing the container engaged with the base.

FIGS. 18A and 18B are perspective views of a container with an integral extension cord capability.

FIGS. 18C and 18D show two arrangements for the base of the container of FIGS. 18A and 18B.

FIG. 19 is a partially cross-sectional view of a container with a built in light source.

### DETAILED DESCRIPTION

This disclosure features a container such as a bucket, trash barrel, planter or the like. There is a base that is constructed and arranged to be coupled to the container. The coupling can be essentially permanent, or it can be impermanent such that the container can be separated from the base. This coupling can be accomplished by including mechanical features such as bosses projecting downwardly from the bottom of the container, and complementary mechanical features projecting upwardly within or from the base. Such upwardly projecting features may be posts that are sized and shaped to fit within the bosses. The features can also be tabs and receiving recesses/slots or the like. The mechanical features on the container and the complementary mechanical features on the base may fit together via an interference fit to accomplish an essentially permanent coupling, in that the plastic material would be permanently deformed if the coupled parts were forcibly separated. The base can define additional functionalities such as retractable wheels, extension cords, lights, storage compartments, swing drawers, or other functionalities.

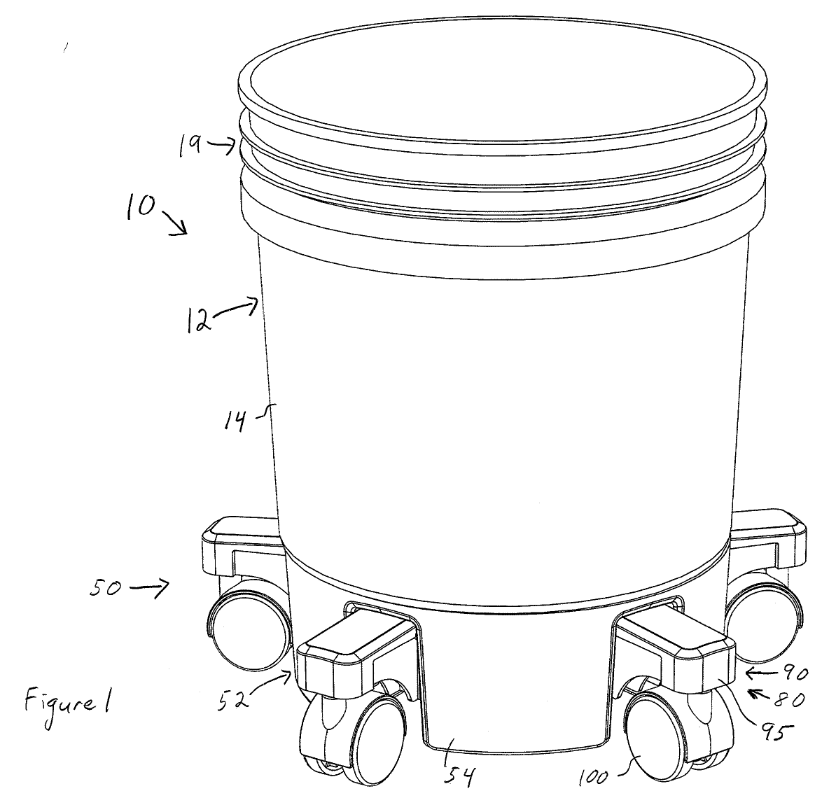

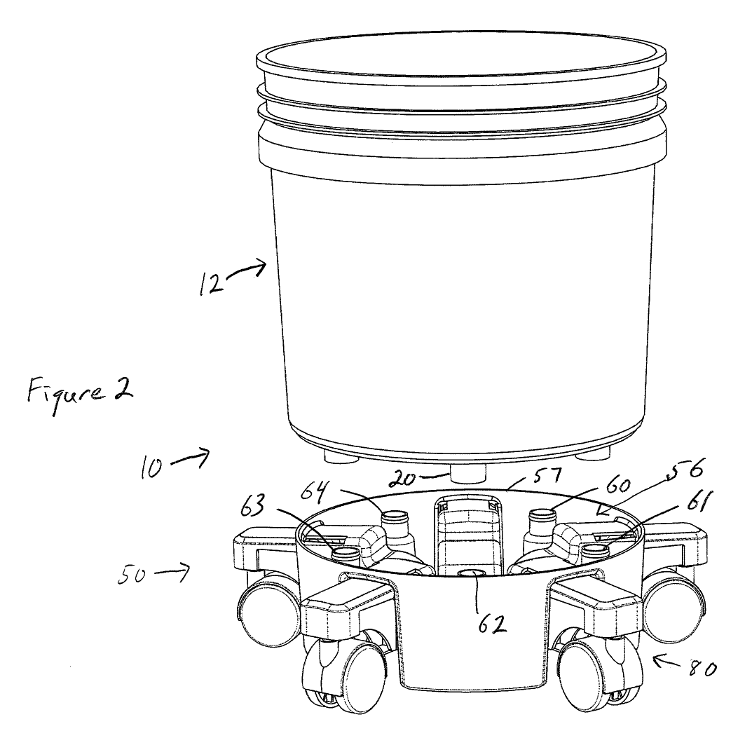

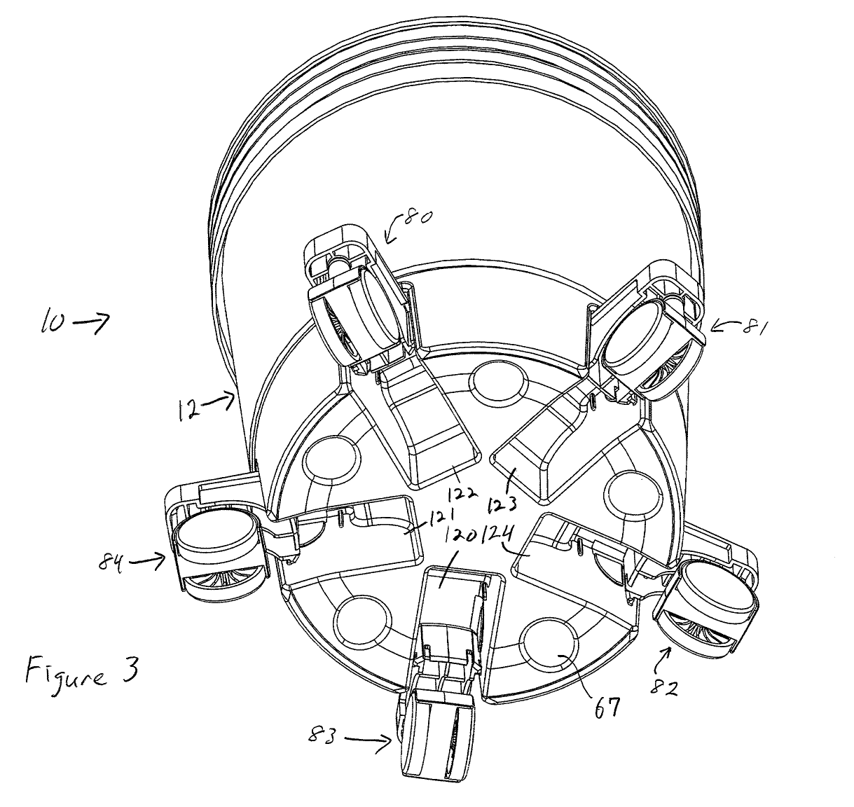

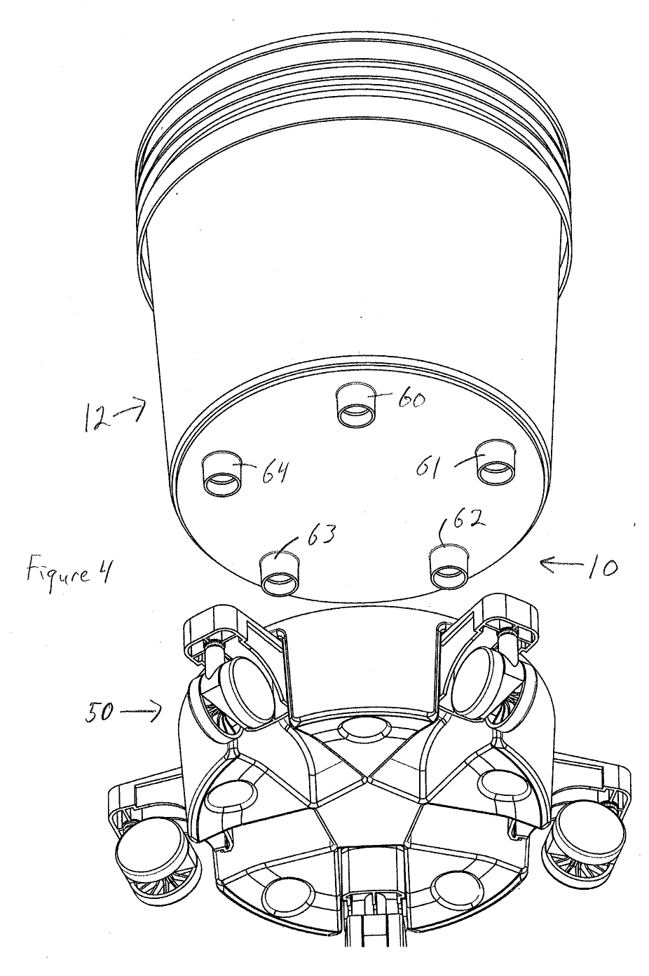

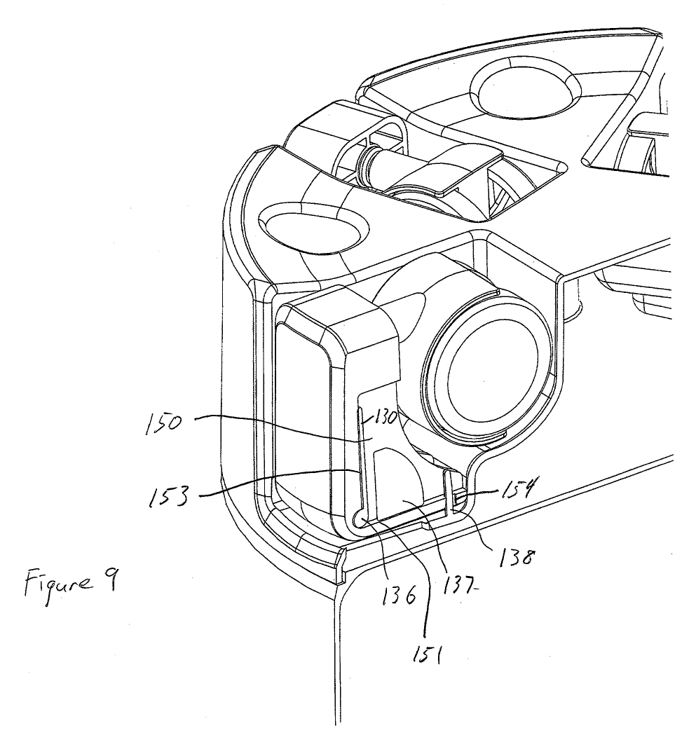

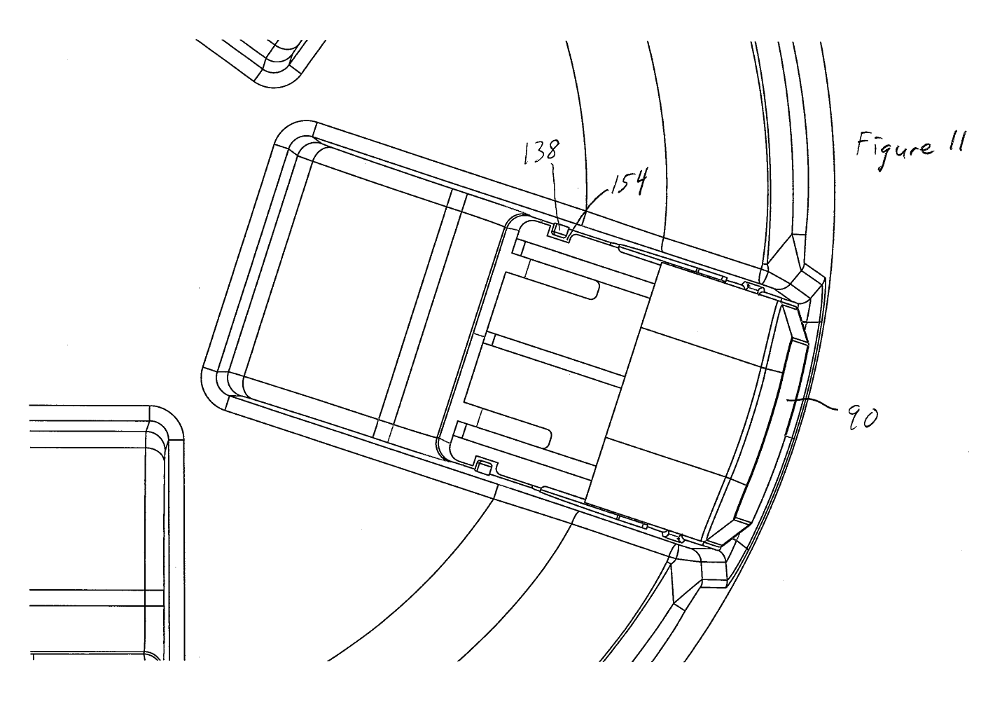

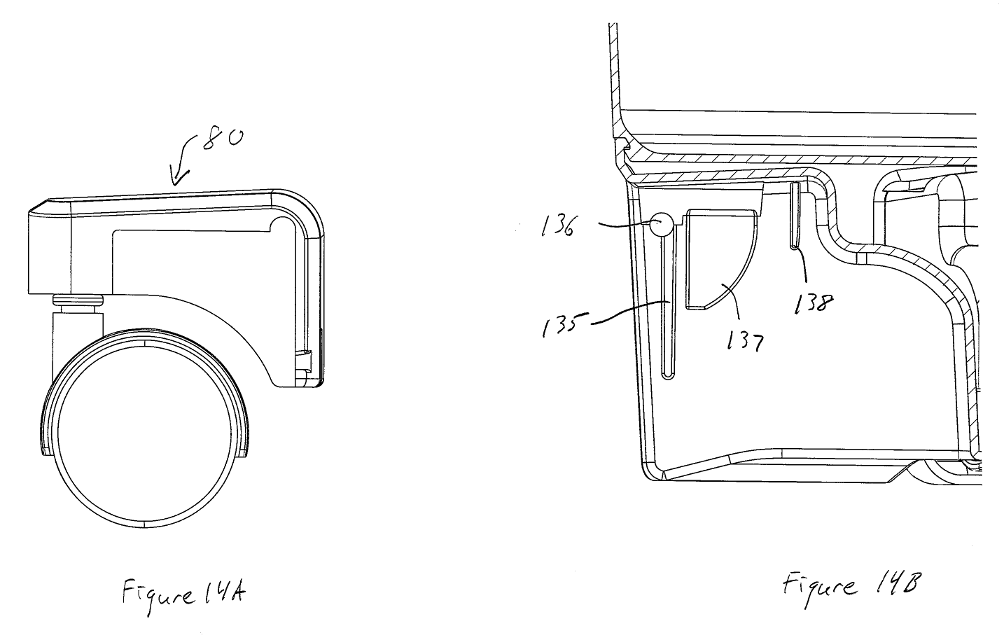

A first embodiment of a container with retractable wheels is shown in FIGS. 1 through 14. Assembly 10 comprises two basic components: container 12 (which in the embodiment is a bucket but could be a different container such as a trash barrel or planter, and could have any perimeter shape, including round as shown in the drawings, rectangular, or a different regular or irregular shape) and base 50. Container 12 and base 50 in this non-limiting example are constructed and arranged to be essentially permanently coupled together via an interference fit accomplished with a number of mechanical features on the container and a number of complementary mechanical features on the base. In this embodiment, assembly 10 comprises retractable wheels that project outwardly from the perimeter shape of the container and base when the wheels are in the deployed position in which they support the container and base. The wheels are retractable to a stowed position in which they do not support the container and base. In the stowed position the wheels are located fully within the base such that they do not extend beyond the perimeter shape of the base.

Container 12 comprises a sidewall 14 with exterior surface 15. Preferably, below the container's top portion 19 that comprises a skirt and strengthening rings, container 12 is continuously tapered inwardly. Base 50 preferably has the same perimeter shape as container 12, and also preferably continues the inward taper of container 12 such that the combination of the two (i.e., assembly 10) defines a continuous external taper along at least the lower part of the container and all or essentially all of the base. This construction replicates the external tapered shape of a typical plastic bucket and allows the assemblies to be nested one within the other which decreases the amount of floor space required for storage, shipment, retail display and the like.

In this embodiment, container 12 comprises a plurality of first mechanical features projecting downwardly from container bottom 16. The features are integral projecting annular bosses 60-64 spaced evenly around the periphery of the bottom. Base 50 includes the same number of second mechanical features projecting upwardly. These projecting features may be located at or below top 56 of base 50, or they may project above the top of the base. In this non-limiting illustrative embodiment, these features are posts 60-64. Each post is sized and shaped to fit within a boss. There are one or more features of the bosses and/or the posts that accomplish an interference fit of the two, in which there is elastic deformation of one or both such features during assembly that results in an essentially permanent coupling that resists de-coupling without (perhaps permanent) deformation of the interlocking features. Alternatively the coupling of the container to the base can be less permanent, which can allow the two to be separated and then reassembled together.

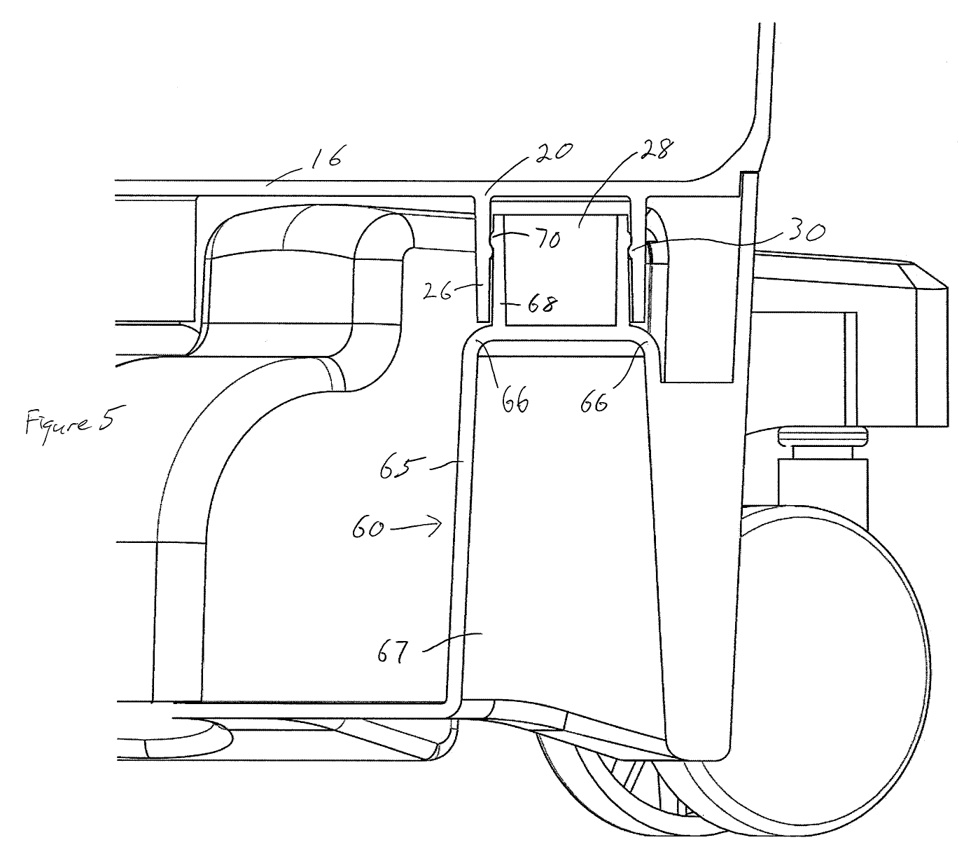

In the embodiment, all of the posts are identical. One post 60 is shown in detail in FIG. 5 and comprises lower sidewall 65 with shoulder 66 defined at the top thereof. Projecting annular wall 68 projects from shoulder 66. Wall 68 carries projecting external ring 70 that accomplishes the interference fit. Boss 20 comprises annular sidewall 26 that defines interior space 28 that is sized and shaped to accept projection 68. Sidewall 26 defines along its inner surface a projecting ring 30 that projects approximately to the external surface of post projection 68. Rings 30 and 70 project beyond one another. As a result, in order to push projection 68 into boss 20 such that boss 20 rests on shoulder 66, ring 70 must be forced past ring 30. Container 12 and base 50 are preferably injection molded from a plastic material such as high density polyethylene. This material can be deformed sufficiently to accomplish this interference fit of post projection 68 into boss 20. In a non-limiting embodiment the rings can have a height of about 0.02 to 0.06″, and in one case are 0.02″. Although this coupling can be reversed if sufficient force is applied to push apart the container and base, in normal use this interference fit is sufficiently robust that the base will not separate from the container, thus the coupling of the two is essentially permanent. Also, separation may cause a permanent deformation of the plastic material.

Essentially permanent coupling of the base to the container of this nature can be accomplished in other manners. One manner is other types of interference fits, for example interference fits accomplished by pushing the two members together, or twisting them relative to each other. The structures used to accomplish the interference fits can vary from those described. For example, one of the container and the base could define a number of shoulders and the other could carry engaging arms that carried terminal hooks that were able to be pushed beyond and then fit behind the shoulders. Other manners of accomplishing an interference fit would be apparent to one skilled in the field and are within the scope of the disclosure herein. Other manners of permanent coupling include use of adhesives and other manners of bonding such as contact welding, rivets, insert molding, over molding and heat staking.

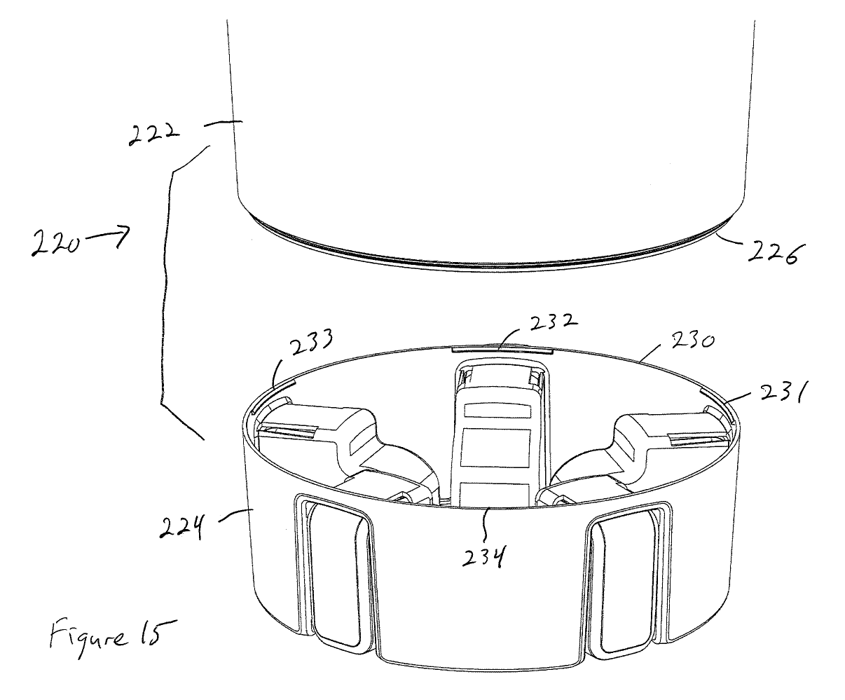

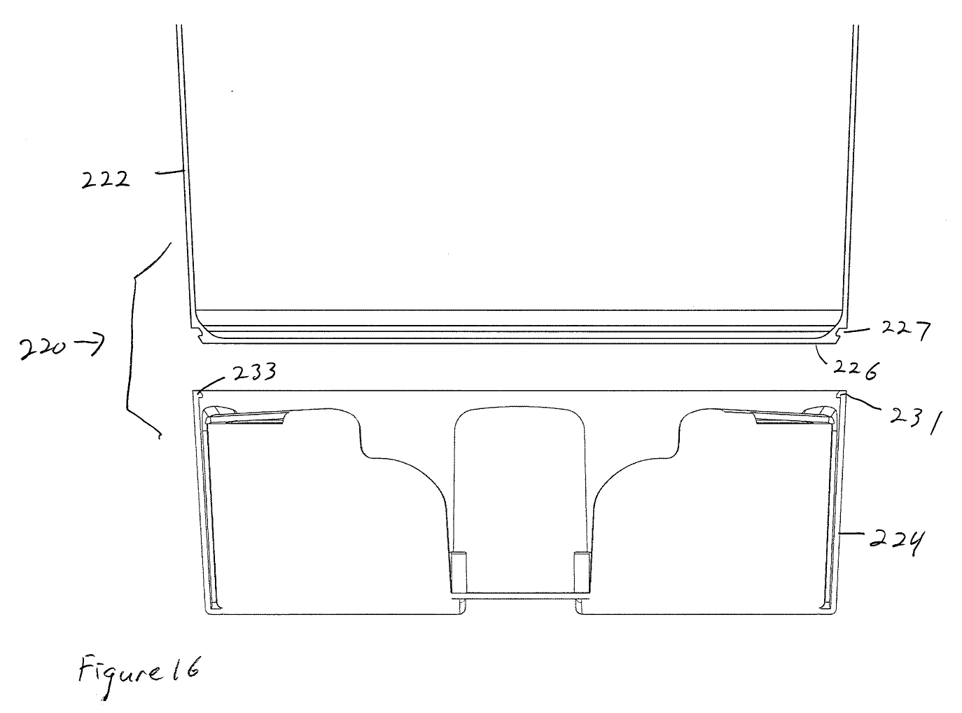

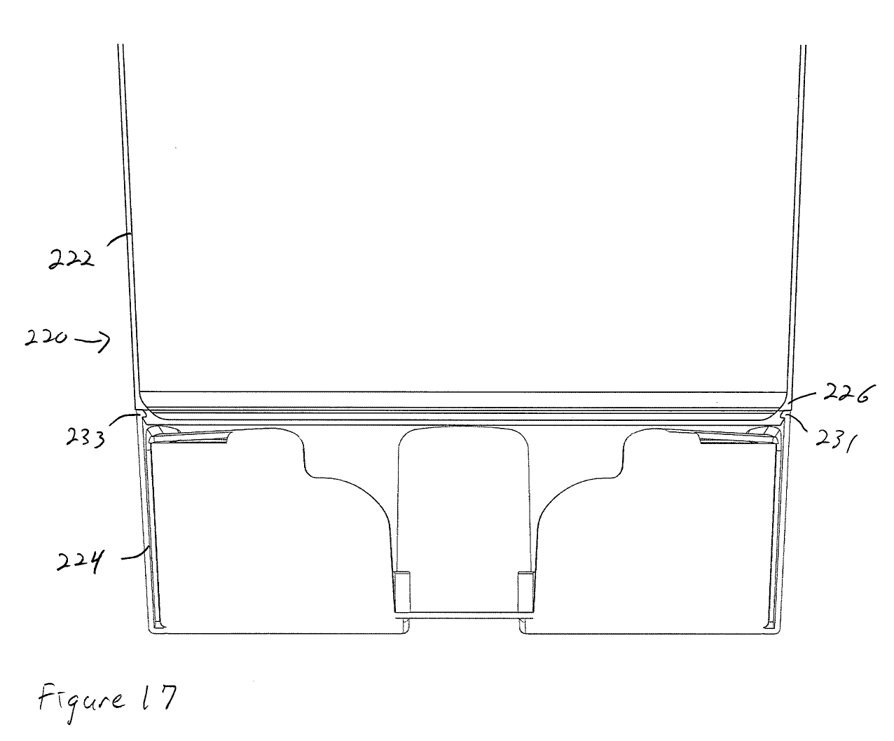

Releasable coupling is an alternative to permanent or essentially permanent coupling. Releasable coupling can be accomplished in a desired manner such as with other types of integral or non-integral interfitting constructions (an example of which is shown in FIGS. 15-17), or with fasteners such as screws bolts or the like, for example. Neither the permanence of the coupling of the container to the base nor the manner in which the coupling is accomplished are limitations of the invention.

Base 50 also comprises a plurality of retractable wheels. The retractable wheel feature is accomplished in this embodiment by five identical wheel assemblies 80-84 that are coupled to base member 52 in a manner in which the wheel assemblies are located fully within a perimeter shape of base member 52 when they are stowed in a position in which the wheels do not support the base and container. There may be more than or fewer than five wheel assemblies. The wheel assemblies and the base are also constructed and arranged such that the wheel assemblies can be pivoted from this stowed position to a deployed position in which the wheels support the base and container on a surface such as a floor. In the deployed position, the wheels are located externally of the perimeter shape of base member 54, and below the lower surface of base 54 member, for example as shown in FIGS. 1-3.

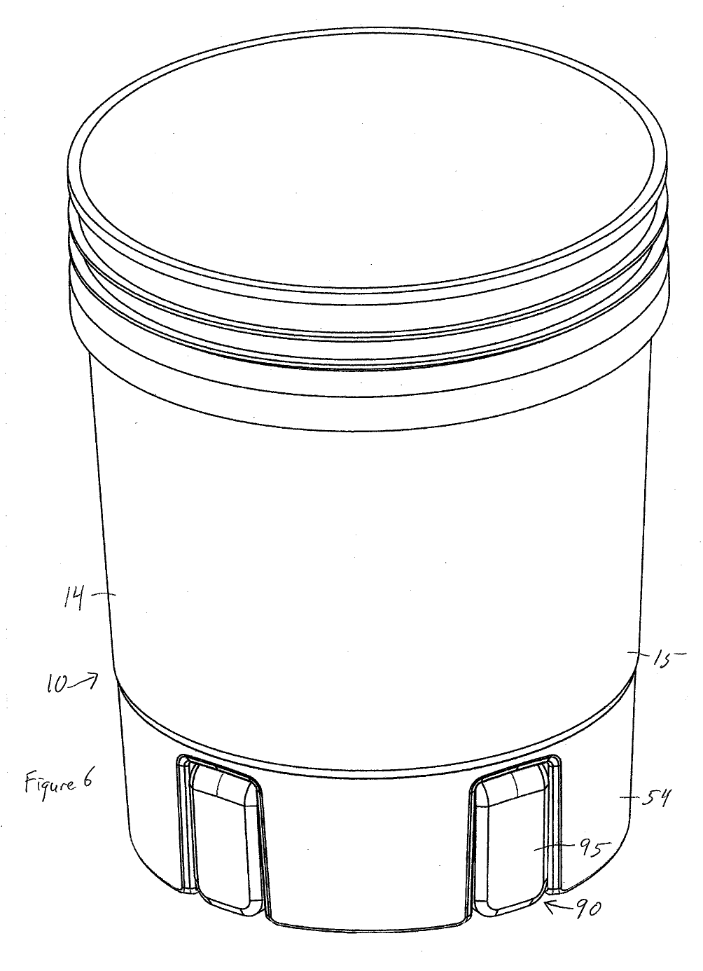

All of the wheel assemblies 80-84 are identical. Details of one wheel assembly 80, and the features on the base that interact with the wheel assembly, are shown in the drawings. Assembly 80 comprises molded plastic unitary leg 90 that defines external surface 95. Caster 100 has a projecting stem, not shown, that is press-fit into leg 90 in a manner of coupling a caster to a leg that is well known in the field and thus not further shown or described. Wheel assembly 80 is sized and shaped to fit entirely within cavity 120 in base member 52. Cavities 121-124 are identical to cavity 120 and thus each are able to fully accommodate one wheel assembly. In the stowed position such as shown in FIG. 6 for example, leg external surface 95 is coincident with or located just inside of the round tapered perimeter shape of base external surface 54. One result is that the wheel assemblies when stowed do not alter the tapered perimeter shape of the assembly, thus allowing assemblies to be nested, one within the other, as can commonly be accomplished with molded plastic five gallon buckets. Assembly 10 thus to a user is essentially identical to such typical five gallon plastic bucket. To make assembly 10 the same height as a five gallon plastic bucket, the volume of container 12 is decreased to accommodate the volume of base 50. The volume of base 50 is approximately 1 gallon. The volume of container 12 is about 4.25 gallons.

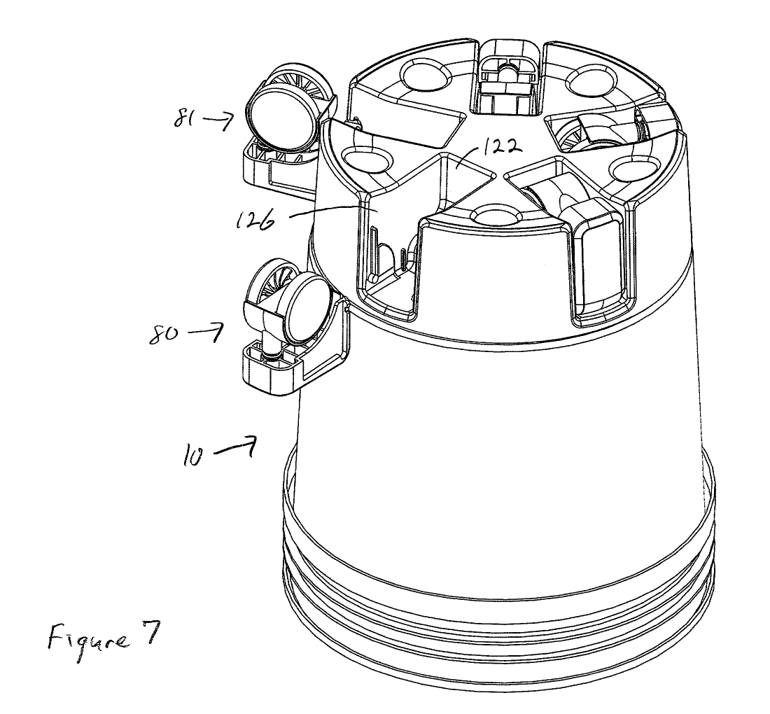

The manner in which the legs are coupled to the base member to allow for the stowing and deployment is depicted in FIGS. 7 through 14. Base member 52 defines a number of cavities 120-124 that are located between the posts as shown in FIG. 7, for example. The cavities are identical to one another. The details of one cavity 120 are shown. Cavity 120 is defined in part by spaced vertical walls 126 and 128 that carry features that interact with complementary features on leg 90 to accomplish an interference fit of leg 90 in cavity 120 and allow leg 90 to be pivoted about walls 126 and 128 without the need for an axle or any structure other than the features integrally molded into base member 52 and legs 90-94.

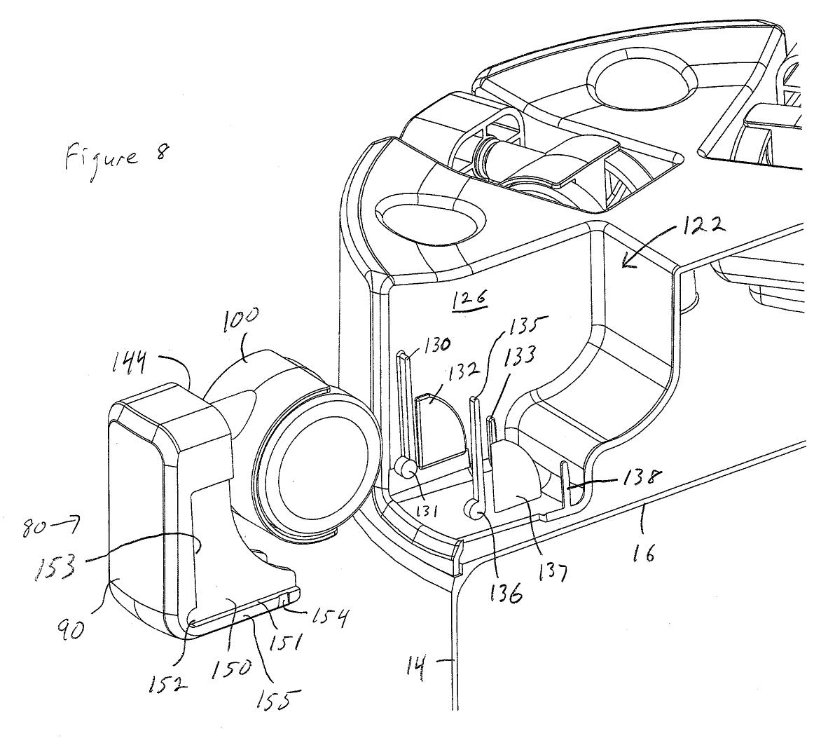

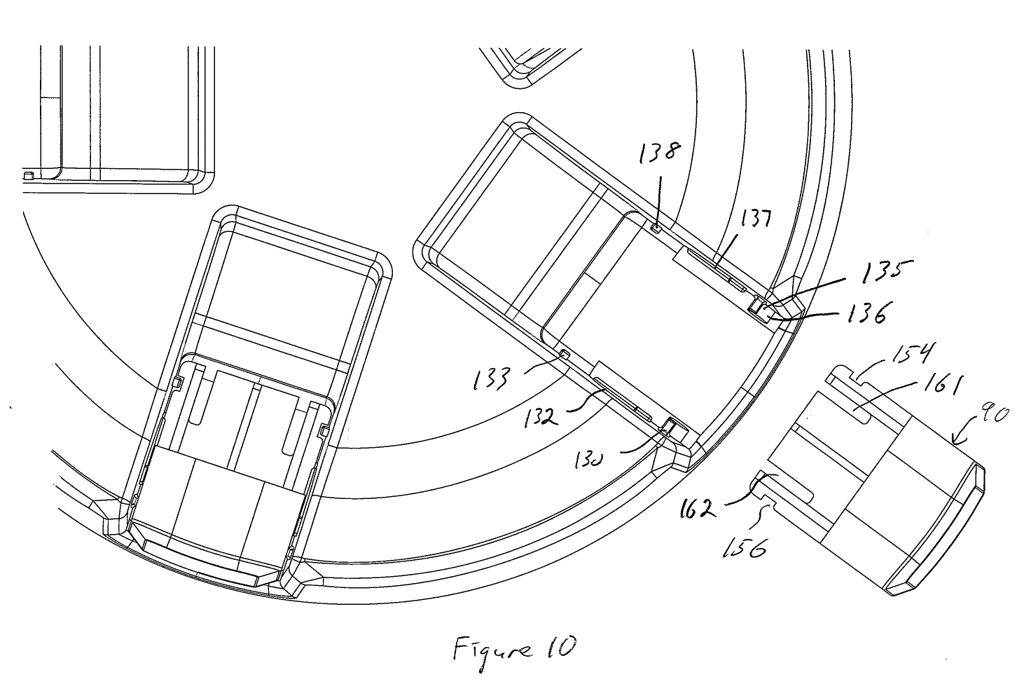

The features integrally molded into walls 126 and 128 include left locking tab 133 and right locking tab 138. These locking tabs fit into left and right receiving slots 156 and 154, respectively, on wheel assembly 80. To couple wheel assembly 80 to the base, the wheel assembly is pushed into the receiving cavity while in the position shown in FIG. 8. Slots 161 and 162 (see FIG. 10) accomplish some compliance such that the fingers that defines slots 154 and 156 can bend inwardly enough to allow the locking tabs to engage in the slots. Tabs 133 and 138 thus lock the wheel assembly to the base.

Left and right pivot and retaining features 130 and 135, respectively, ride in recessed faces that are defined on both sides of the wheel assembly (right recessed face 150 shown in the drawings) and rest against one rim of the recess (e.g., right side second shoulder or stop feature 153 shown in the drawings) when the wheel assembly is stowed. They rest against the other rim (e.g., left side first shoulder or stop feature 151 shown in the drawings) when the wheel assembly is deployed. Projecting shelves 132 and 137 contact the recessed faces to accomplish some friction between the wheel assembly and the recess, so that the relative motions of the two are more controllable. Pivot features 131 and 136 fit into receiving recesses (right receiving recess 152 shown in the drawings) so as to define a horizontal axis about which wheel assembly 80 pivots when being moved between the stowed and deployed positions.

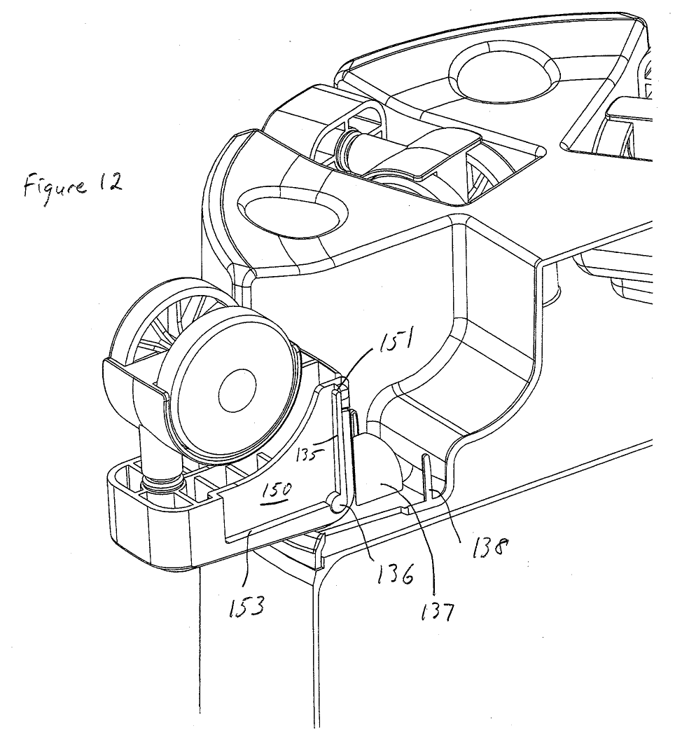

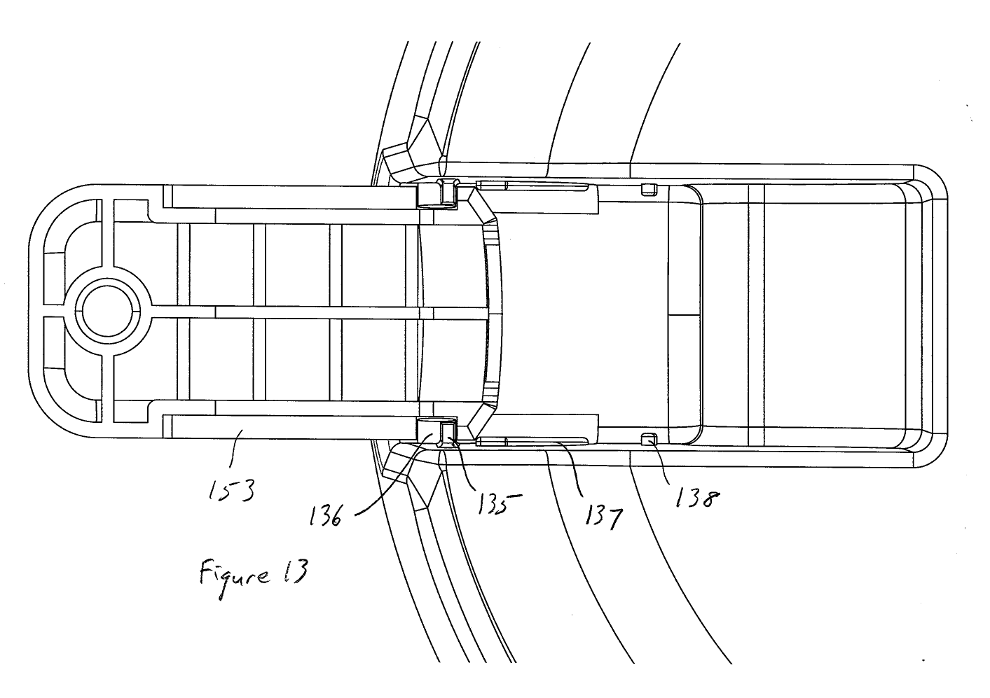

Wheel assembly 80 is moved to its deployed position (shown in FIGS. 12 and 13, for example) by grasping rim 144 (FIG. 8) and pulling outward. This causes wheel assembly 80 to pivot about the pivot receiving cavities (right side cavity 152 shown in the drawings) until the retaining features 130 and 135 contact the first shoulders or stop features such as feature 151 that is located between rim 155 and recessed face 150. See FIGS. 12 and 13.

The assembly could be accomplished with a base that is integral with the container, in other words with a container that has a base portion that defines the wheel assembly receiving cavities. Also, other manners of accomplishing retractable wheels are also contemplated. The wheels preferably stow within the perimeter contour of the assembly, but they need not do so. For example, the wheels could retract sufficiently such that they were at least partially within the perimeter contour of the base. Also, the mechanism that accomplishes the necessary movement of the wheels relative to the base member can be different than that described above. As one simple example, the legs could be coupled to the base member via an axle, or the pivoting could be about a vertical axis rather than a horizontal axis as described above.

A second embodiment, assembly 220, is shown in FIGS. 15-17. In this case container 222 and base 224 are separable. Also, the interior of the base is more open, leaving room for the addition of other features such as storage compartments, tool boxes or the like. The space could potentially have a swing drawer or compartment used for small tools, fasteners and other hardware, and the like. Coupling of the container to the base is accomplished via inwardly-projecting tabs 231-234 on upper rim 230 of base 224, which fit into circumferential slot 227 in lower rim 226 of container 222. This arrangement also does not require any particular circumferential alignment, as slot 227 extends all the way around the circumference of rim 226.

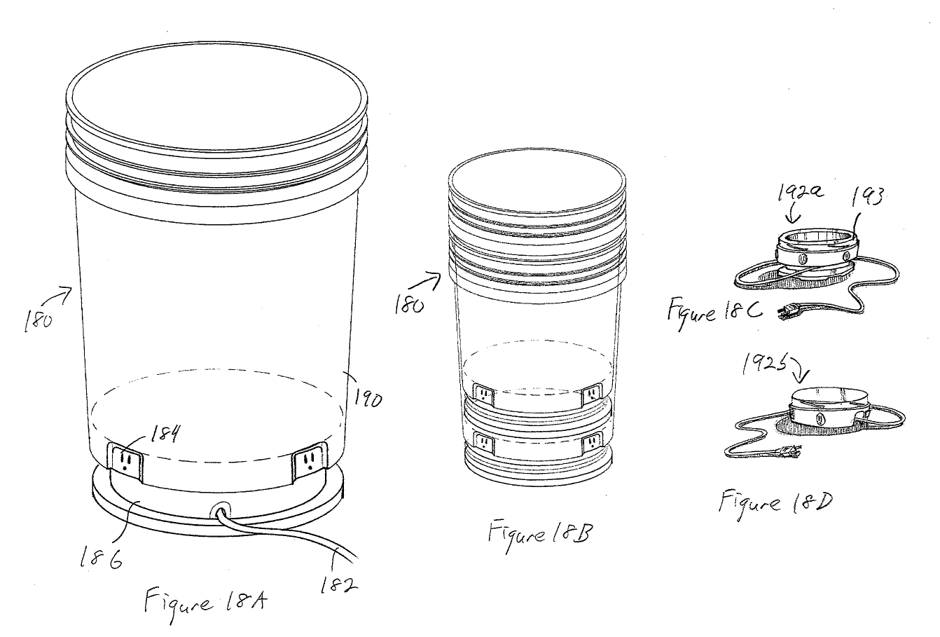

FIGS. 18A and 18B show another assembly 180 that comprises a container 190 that is coupled to base 192. Base 192 in this embodiment includes extension cord 182 and one or more electrical receptacles 184. When extension cord 182 is plugged into a live receptacle, it feeds electrical power to receptacles 184. Assembly 180 thus is both a container and a portable power station. Base 192 defines circumferential groove 186 that is located within the external perimeter shape of base 192 and has a volume that is sufficient to hold the entirety of extension cord 182. As a result, extension cord 182 can be wrapped around the base within groove 186 and lie fully within the tapered perimeter shape of base 192 so that when the extension cord is in the stowed position as shown in FIG. 18B, a number of assemblies 180 can be nested one within the other as described above relative to assembly 10.

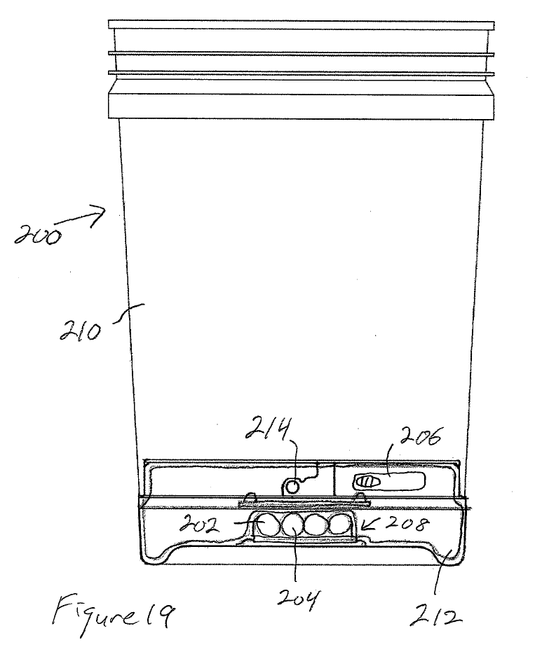

Base 192 can be mechanically coupled to container 180 in various manners. One manner is as described above relative to assembly 10, with complementary projecting mechanical features at the bottom of container 190 and the top of base 192. Alternatives include releasable attachment such as a partial turn bayonet-type locking engagement (shown in more detail in FIG. 19), snap-over flex tabs (not shown in the drawings), fasteners such as screws, or a partial turn threaded engagement as shown in base 192a, FIG. 18C and base 192b, FIG. 18D. A projecting thread 193 is shown in base 192a to illustrate this partial turn threaded engagement coupling. A complementary mating thread structure would be molded into a projecting annular flange in the bottom portion of container 180 to allow base 192 to be mechanically coupled to container 180 via relative rotation of the two, as with any screw thread engagement.

FIG. 19 shows features of assembly 200 that carries a light source. Container 210 is coupled to base 212 in a manner as described above. In this case the coupling is accomplished by a bayonet locking engagement 214 accomplished with one or more projecting studs in the bottom of the container that engage with complementary shaped slots in base member 212. Base member 212 carries printed circuit board 208 that itself carries light source 202 and one or more batteries 204. Manually operated switch 206 controls power flow from the batteries to the light source and can be a multi-position switch to allow intermittent or flashing operation as well as steady operation of the light.

What is claimed is:

1. A wheeled dolly, comprising:
a base member having a perimeter shape; and
a plurality of retractable wheel assemblies coupled to the base member, wherein the wheel assemblies each comprise a leg that carries a wheel;
wherein the base member defines a cavity for each wheel assembly such that in a stowed position the wheel assemblies fully fit within the cavities and the legs define a portion of the perimeter shape of the base member.

2. The wheeled dolly of claim 1 wherein the cavities are defined by cavity walls in the base member.

3. The wheeled dolly of claim 2 wherein the legs are coupled to and rotate relative to the cavity walls.

4. The wheeled dolly of claim 3 wherein the walls of each cavity define one or more first features that are complementary to one or more second features on the leg, to allow the leg to be coupled to the cavity walls.

5. The wheeled dolly of claim 4 wherein two stop positions are defined between the walls of each cavity and the leg that is coupled to such walls.

6. The wheeled dolly of claim 5 wherein the stop positions are defined by projecting features on either both of the walls or the leg, and receiving features on the other of either both of the walls or the leg.

7. An assembly, comprising:
a container having a perimeter shape; and
a plurality of retractable wheel assemblies coupled to the container, wherein the wheel assemblies each comprise a leg that carries a caster, and wherein the container defines a cavity for each wheel assembly, wherein in a stowed position the wheel assemblies fully fit within the cavities and the legs define a portion of the perimeter shape of the container.

8. The assembly of claim 7 wherein the container defines a base portion, and the base portion defines the cavities.

9. The assembly of claim 8 comprising a container portion and a separate base portion that is mechanically coupled to the container portion.

10. The assembly of claim 7 wherein the container perimeter shape is tapered at least toward the lower end of the container.

11. A wheeled dolly that is adapted to be coupled to an apparatus that is supported by the dolly, the apparatus comprising a plurality of first mechanical features, the dolly comprising:
a base comprising a base member and a plurality of second mechanical features;
a plurality of wheel assemblies coupled to the base member and adapted to rest on a surface to support the base member above the surface; and
wherein the apparatus has a bottom and the first mechanical features are integral with the bottom, and wherein the dolly has a top and the second mechanical features are integral with the top.

12. The wheeled dolly of claim 11 wherein the first and second mechanical features are matching features that fit together in an interference fit when the apparatus is coupled to the dolly.

13. The wheeled dolly of claim 11 wherein the apparatus comprises a container.

14. The wheeled dolly of claim 13 wherein the container has a round perimeter shape.

15. The wheeled dolly of claim 14 defining a continuous external taper along at least the lower part of the container and all of the base.

16. The wheeled dolly of claim 11 wherein the first mechanical features comprise raised annular bosses.

17. The wheeled dolly of claim 16 wherein the second mechanical features comprise posts.

18. The wheeled dolly of claim 17 wherein the posts are at least in part located within the bosses.

19. The wheeled dolly of claim 18 wherein the posts and bosses each define one or more projecting rings, and the interference fits are accomplished at least in part by a ring on a post moving past a ring on a boss.

20. The wheeled dolly of claim 19 wherein each post defines a shoulder and a projection above the shoulder, and wherein the projections are located in the bosses, and the bosses sit on the shoulders.

21. The wheeled dolly of claim 11 wherein the wheel assemblies are retractable.

22. The wheeled dolly of claim 21 wherein the wheel assemblies each comprise a leg that carries a wheel.

23. The wheeled dolly of claim 22 wherein the base member defines a cavity for each wheel assembly, and wherein in a stowed position the wheel assemblies fully fit within the cavities and the legs define a portion of the perimeter shape of the base.

24. The wheeled dolly of claim 23 wherein the cavities are defined by cavity walls in the base member.

25. The wheeled dolly of claim 24 wherein the legs are coupled to and rotate relative to the cavity walls.

26. The wheeled dolly of claim 25 wherein the walls of each cavity define one or more first features that are complementary to one or more second features on the leg, to allow the leg to be coupled to the cavity walls.

27. The wheeled dolly of claim 26 wherein two stop positions are defined between the walls of each cavity and the leg that is coupled to such walls.

28. The wheeled dolly of claim 27 wherein the stop positions are defined by projecting features on either both of the walls or the leg, and receiving features on the other of either both of the walls or the leg.

29. The wheeled dolly of claim 11 wherein the container is a bucket.

30. The wheeled dolly of claim 29 wherein the bucket and the base are each made of molded plastic.

31. The wheeled dolly of claim 11 wherein the base further comprises an extension cord and one or more electrical receptacles powered by electrical power carried by the cord.

32. The wheeled dolly of claim 31 wherein the base defines a circumferential groove into which the extension cord fits so as to be fully within the perimeter shape of the base.

33. The wheeled dolly of claim 11 wherein the base further comprises a light, a battery power source for the light, and a switch that controls power flow from the power source to the light.

34. An assembly, comprising:
a molded plastic bucket having a round perimeter shape and a bottom, and comprising a plurality of raised annular bosses projecting outwardly from the bottom;
a molded plastic base member having a round perimeter shape and a top, and comprising a plurality of posts projecting upwardly and located proximate the top, the posts each defining a shoulder and a projection above the shoulder;
a plurality of wheel assemblies, the wheel assemblies each comprising a leg that carries a caster;
wherein the base member defines a cavity for each wheel assembly, and wherein in a stowed position the wheel assemblies fully fit within the cavities and the legs define a portion of the perimeter shape of the base member, wherein the cavities are defined by cavity walls in the base member and the legs are coupled to and rotate relative to the cavity walls, wherein the walls of each cavity define features that interfit with the leg that is coupled to such walls, wherein two stop positions are defined between the walls of each cavity and the leg that is coupled to such walls;
wherein the bucket and the base are fixedly coupled together via interference fits between the bosses and the posts, wherein each post fits within one of the bosses with the boss sitting on a shoulder, and wherein the posts and bosses each define projecting external rings and the interference fits are accomplished at least in part by the rings on the posts moving past the rings on the bosses; and
wherein the assembly defines a continuous external taper along at least the lower part of the bucket and essentially all of the base when the wheel assemblies are in the stowed position.

35. An assembly, comprising:
a molded plastic bucket having a round perimeter shape and a bottom rim, and comprising a groove defined in the bottom rim;
a molded plastic base member having a round perimeter shape and a top rim, and comprising a plurality of tabs projecting inwardly from the top rim;
a plurality of wheel assemblies, the wheel assemblies each comprising a leg that carries a caster;
wherein the base member defines a cavity for each wheel assembly, and wherein in a stowed position the wheel assemblies fully fit within the cavities and the legs define a portion of the perimeter shape of the base member, wherein the cavities are defined by cavity walls in the base member and the legs are coupled to and rotate relative to the cavity walls, wherein the walls of each cavity define features that interfit with the leg that is coupled to such walls, wherein two stop positions are defined between the walls of each cavity and the leg that is coupled to such walls;
wherein the bucket and the base are coupled together by the base member tabs fitting into the groove in the bottom rim of the bucket; and
wherein the assembly defines a continuous external taper along at least the lower part of the bucket and essentially all of the base when the wheel assemblies are in the stowed position.
